(19) United States
(12) Patent Application Publication
(10) Pub. No.: US 2007/0155476 A1
(43) Pub. Date: Jul. 5, 2007

(54) GAMING MACHINE

(75) Inventor: Masatsugu KOBAYASHI, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/557,246

(22) Filed: Nov. 7, 2006

(30) Foreign Application Priority Data
Nov. 11, 2005 (JP) P2005-327365

(51) Int. Cl. A63F 13/00

(52) U.S. Cl. 463/20

(57) ABSTRACT

In a slot machine, a number of times to execute a single game continuously is set in a game condition setting process and the required number of credits is determined based on the number of times. A lottery is drawn for the number of times, and the game is played based on the lottery result. On the basis of the set number of times, a staging pattern performed on a lower image display panel and a required time per game for execution of a single game are determined so that the single game is executed in the determined required time per game, and the staging on the basis of the determined staging pattern is performed while the game for the number of times is continuously executed.

### CROSS REFERENCE TO RELATED APPLICATIONS

This application is based upon and claims the benefit of priority from the prior Japanese Patent Application No. 2005-327365, filed on Nov. 11, 2005; the entire contents of which are incorporated herein by reference.

### BACKGROUND OF THE INVENTION

1. Field of the Invention

The present invention relates to a gaming machine which provides variable display of symbols and stops to display symbols on the basis of a lottery result, and provides an award to a player on the basis of a stop mode.

2. Related Background of the Invention

In a conventional gaming machine such as a slot machine, pachinko slot, etc., variable display of symbols is started by input of a gaming medium such as a medal into the gaming machine and a predetermined operation, and stopped symbols are displayed on the basis of a lottery result of a lottery executed inside the gaming machine. The conventional gaming machine is configured such that, on the basis of the stop mode of symbols (that is, a plurality of symbols in a stopped state), a predetermined amount of gaming media is paid out (In a slot machine, for example, predetermined symbols are displayed in the stopped state on a winning line.).

That is, in such a gaming machine, a flow from variably displaying symbols to displaying symbols in the stopped state on the basis of a lottery result constitutes a single game. That is, a single game corresponds to one lottery result (hereinafter, the above “single game” is referred to as a base game).

Also, there is a gaming machine configured such that a special game advantageous to the player (a bonus game such as a free game, for example) can be played when the stop mode of symbols is a predetermined one. In this case, in the above special game state, further diversified staging are executed to give an effect to increase interest in the special game.

Here, at a base game execution in such a gaming machine, a player only watches the variable display of symbols during the time from variably displaying symbols to displaying symbols in the stopped state on the basis of a lottery result, which gives a monotonous impression. In this point, as an invention to solve the problem that the monotonous impression of the base game is given to players, a gaming machine described in Japanese Patent Application Laid-Open No. 2001-87452 is known. In the invention described in Japanese Patent Application Laid-Open No. 2001-87452, effect display is made on a CRT display at the execution of a base game and this effect display increases interest in the base game without giving the monotonous impression to the player.

### SUMMARY OF THE INVENTION

An object of the present invention is to provide a gaming machine capable of various staging and of improving the operating rate of the gaming machine.

The present invention provides a gaming machine comprising: a gaming medium input means by which a gaming medium used as a consideration of game execution is to be inputted; a permitting means for permitting execution of a game when the gaming media inputted by the gaming medium input means reach a required amount; a staging means for staging at the game execution; a plurality of rows of variable display means for variable display of a plurality of symbols; a lottery means for drawing a lottery of a stop mode of symbols displayed in the stopped state in the variable display means; and an award providing means for providing an award to a player on the basis of a lottery result of the lottery means; a lottery setting means for setting a number of times of the lottery by the lottery means; a lottery control means for drawing a lottery by the lottery means for the number of times set by the lottery setting means; a game executing means for executing the game for the number of times as one set on the basis of the lottery result for the number of times set by the lottery setting means; and a staging setting means for setting a staging to be executed by the staging means on the basis of the lottery result for the number of times set by the lottery setting means.

### BRIEF DESCRIPTION OF THE DRAWINGS

FIG. 1 is a perspective view showing an appearance of a slot machine according to an embodiment.

FIG. 2 is an explanatory view showing the periphery of a game setting portion of the slot machine in an enlarged manner.

FIG. 3 is a pattern diagram showing a row of symbols drawn on the outer circumferential face of each reel.

FIG. 4 is a block diagram showing a control system of the slot machine according to the embodiment.

FIG. 5 is a flowchart of a main control program in the slot machine according to the embodiment.

FIG. 6 is a flowchart of a main game process program in the slot machine according to the embodiment.

FIG. 7 is a flowchart of a game condition setting process program in the slot machine according to the embodiment.

FIG. 8 is an explanatory diagram of a discount rate table used in a required credit number determining process.

FIG. 9 is a flowchart of a lottery process program of the slot machine according to the embodiment.

FIG. 10 is a table showing winning patterns and an achievement probability and payout of each winning pattern of the slot machine in the embodiment.

FIG. 11 is a flowchart of a reel rotation control process program of the slot machine according to the embodiment.

FIG. 12 is an explanatory diagram of a required time table used in a staging mode determining process.

FIG. 13 is an explanatory diagram of a staging pattern table used in the staging mode determining process.

FIG. 14 is an explanatory diagram showing a required time when single game is played three times and the number of times to be played is set to three times.

FIG. 15 is a flowchart of a bonus game process program of the slot machine in the embodiment.

### DESCRIPTION OF THE PREFERRED EMBODIMENTS

The gaming machine according to the present invention will be described below in detail referring to the attached drawings based on an embodiment of a slot machine 1.

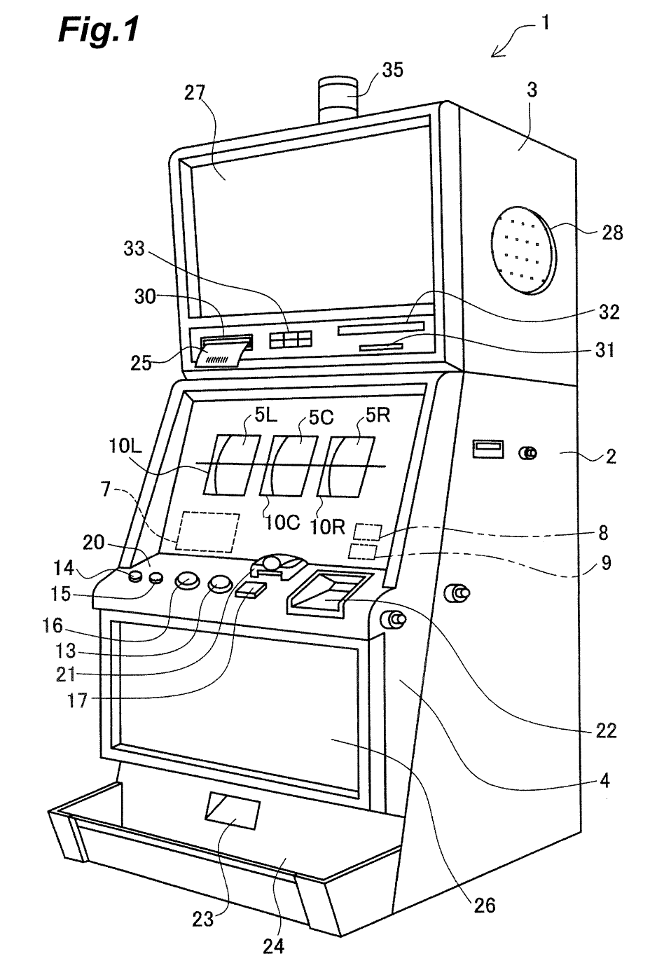

First, an outline construction of the slot machine 1 according to the embodiment will be described on the basis of FIG. 1. FIG. 1 is a perspective view of an outline of the slot machine according to the embodiment.

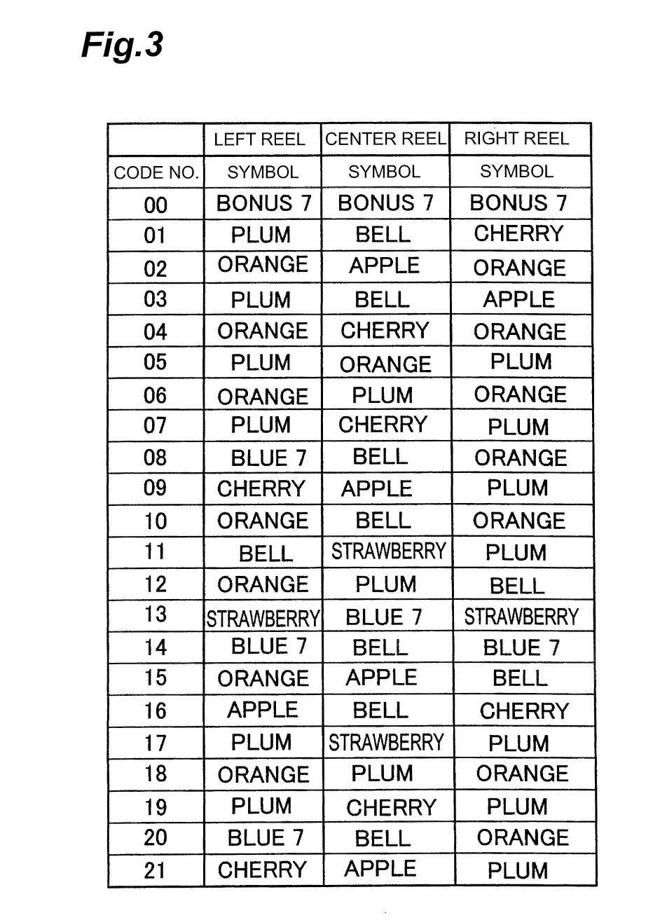

The slot machine 1 according to the embodiment comprises a cabinet 2, a top box 3 arranged above the cabinet 2, and a main door 4 provided on the front face of the cabinet 2. Inside the cabinet 2, three reels 5L, 5C, and 5R are provided rotatably. On the outer circumferential face of each of reels 5L, 5C, and 5R, a symbol row (See FIG. 3) made of 22 picture symbols (hereinafter also referred to as symbols) is drawn.

Also, on the front of each of the reels 5L, 5C, and 5R in the main door 4, a lower image display panel 6 is provided. The lower image display panel 6 is provided with a transparent liquid crystal panel, which displays various information on the game or staging images during the game. The lower image display panel 6 is an image output device and functions as an output means capable of outputting images.

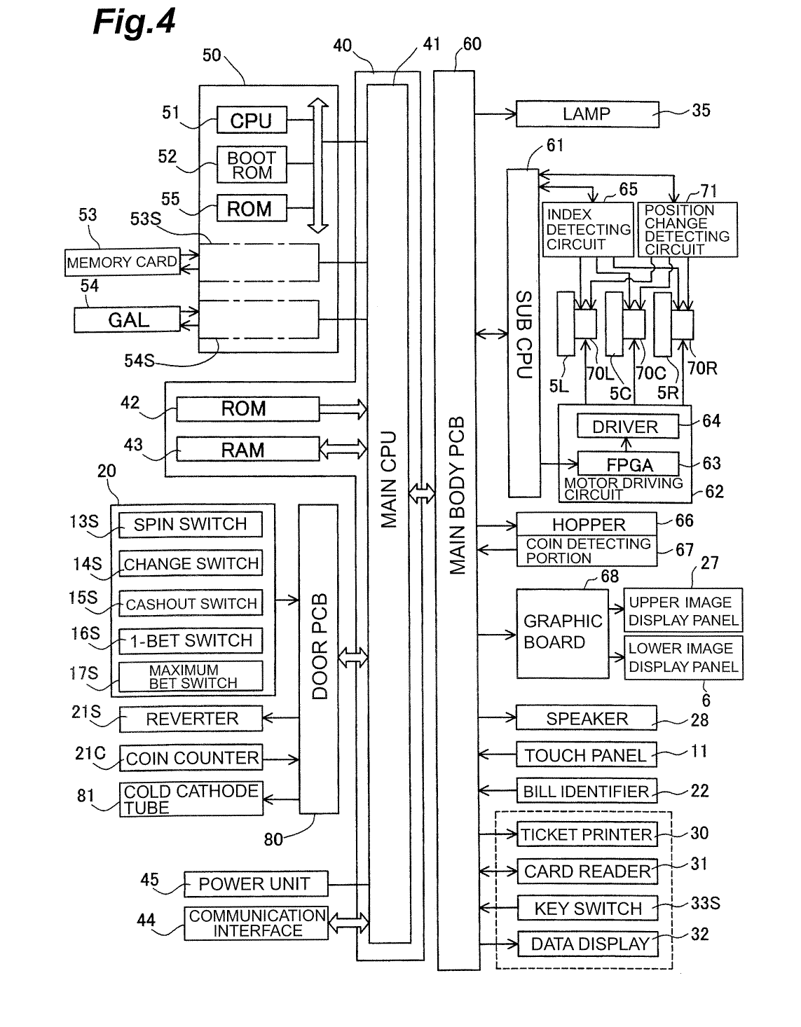

Moreover, on the front face of the lower image display panel 6, a touch panel 11 is provided (See FIG. 4) so that a player can input various instructions by operating the touch panel 11. In this regard, a game setting portion 7, which will be described later, is operated by operating the touch panel 11 of an applicable portion.

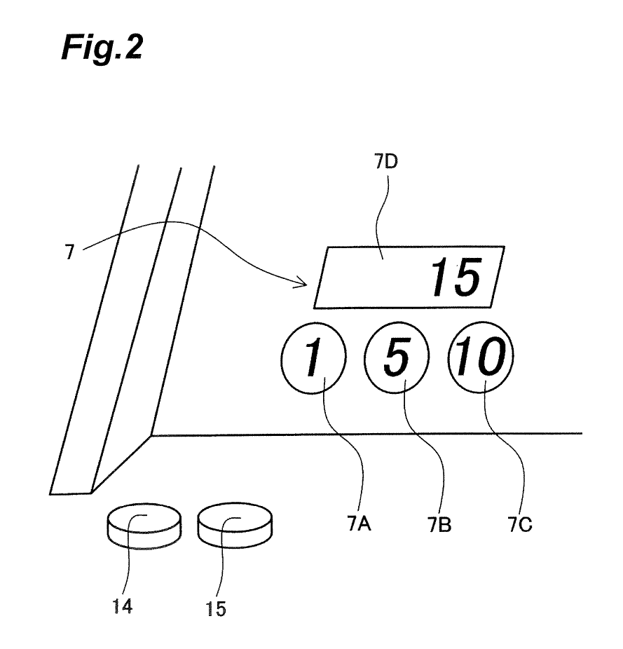

Further, as shown in FIG. 2, on the lower image display panel 6, the game setting portion 7, a credit number display portion 8 and a payout number display portion 9 are provided. The game setting portion 7 is used to set the number of times of the game to be played during a single set (the number of times of base game executed continuously). In this game setting portion 7, a first game setting portion 7A, a second game setting portion 7B and a third game setting portion 7C are formed, and the number of times constituting a single set, that is, the number of times of base-game executed continuously can be set by operating them. That is, when the first game setting portion 7A is operated, “1” is added to a set value of the number of times of game. Similarly, “5” is added for the case of the second game setting portion 7B and “10” for the case of the third game setting portion 7C.

Also, in the game setting portion 7, a number-of-times display portion 7D is formed to display the currently set number of times of the game to be played.

Besides, in the embodiment, the maximum value of the number of times that can be set is 100.

Further, at the credit number display portion 8, the number of credits currently owned by the player is displayed in an image. At the payout number display portion 9, the number of credits to be paid out when the combination of symbols displayed in the stopped state on a winning line L is a predetermined one is displayed in an image.

On the other hand, three display windows 10L, 10C, and 10R whose back faces can be seen are formed on the lower image display panel 6, and three symbols each drawn on the outer circumferential face of each of the reels 5L, 5C, and 5R are displayed through each of the display windows 10L, 10C, and 10R. Also, one winning line L horizontally crossing the three display windows 10L, 10C, and 10R is formed in the lower image display panel 6. The winning line L specifies a combination of symbols, and if the combination of symbols displayed in the stopped state on the winning line L is a predetermined one, the credits according to the combination and the betted credit number (bet number) are paid out.

Note that, in the present invention, it may be configured such that a plurality of winning lines L crossing the three display windows 10L, 10C, and 10R horizontally or diagonally are formed, for example, and the number of winning lines L corresponding to the bet number is validated, and if the combination of symbols displayed in the stopped state on the validated winning line L is a predetermined one, payout according to the combination is paid out.

Also, below the lower image display panel 6, a control panel 20 on which a plurality of buttons by which instructions relating to the progress of the game are inputted by the player are disposed, a coil slot 21 for receiving coins, which are gaming media, into the cabinet 2, and a bill identifier 22 are provided.

On the control panel 20, a spin button 13, a change button 14, a CASHOUT button 15, a 1-BET button 16, and a maximum BET button 17 are provided. The spin button 13 is an operating means for inputting an instruction to start rotation of the reels 5L, 5C, and 5R. The change button 14 is an operating means used for requesting currency exchange to a staff of the game facilities. The CASHOUT button 15 is an operating means for input of an instruction to pay out coins corresponding to the number of credits owned by the player (one credit corresponds to one coin) from a coin payout slot 23 to a coin tray 24 or an instruction of payout by a bar-coded ticket 25, which will be described later.

The 1-BET button 16 is an operating means for receiving an instruction to bet one credit on the game among the credits owned by the player. Also, the maximum BET button 17 is an operating means for receiving an instruction for betting the maximum credit number (50 credits in the embodiment), which can be bet on a single game, on the game.

Inside the coin slot 21, a reverter 21S and a coin counter 21C (See FIG. 4) are provided. And adequacy of the coin inputted into the coin slot 21 is identified and those other than legitimate coins are ejected from the coin payout slot 23 by the reverter 21S. Also, the accepted legitimate coins are detected by the coin counter 21C, and the number of coins is counted.

Further, the bill identifier 22 identifies adequacy of a bill and receives legitimate bills into the cabinet 2. Then, the bills inputted into the cabinet 2 are converted to the number of coins, and the credits corresponding to the converted number of coins are added as the credits owned by the player. Besides, the bill identifier 22 is also configured to be able to read the bar-coded ticket 25, which will be described later. On the lower front face of the main door 4, that is, below the control panel 20, a berry glass 26 on which characters or the like of the slot machine 1 are drawn is provided.

In the slot machine 1 according to the embodiment, coins, bills or electronic valuable information (credit) corresponding to them are used as gaming media. However, the gaming media in the present invention is not limited to them, but medals, tokens, electronic money or tickets, for example, may be used.

On the front face of the top box 3, an upper image display panel 27 is provided. On the upper image display panel 27, a liquid crystal panel is provided to display images showing introduction of the game contents or explanation of the rule of the game, for example.

Further, on the side face of the top box 3, a speaker 28 is provided. The speaker 28 functions as an output means capable of sound output. Below the upper image display panel 27, a ticket printer 30, a card reader 31, a data display 32 and a key pad 33 are provided.

Here, the ticket printer 30 is a printing device for printing barcodes with coded data such as the number of credits, time and date and the identification number of the slot machine 1 on a ticket and outputting it as the bar-coded ticket 25. Then, the player can play a game on the gaming machine by having the outputted bar-coded ticket 25 read by another gaming machine or can exchange it for prizes or the like at a predetermined location in the game facilities.

The card reader 31 is to read/write data from/to a smart card. The smart card is a card owned by a player, and data relating to history of the game played by the player, for example, is stored. Data corresponding to the coins, bills or credits may be stored in the smart card. Alternatively, a magnetic stripe card may be employed instead of the smart card.

The data display 32 is made of a fluorescent display or the like and this is a display means for displaying data read out by the card reader 31 or data inputted by the player via the key pad 33.

Also, the key pad 33 is an operating means for inputting instructions or data relating to ticket issuance or the like.

Moreover, a lamp 35 is provided on the upper face of the top box 3. The lamp 35 is lighted in a predetermined lighting mode when an error occurs in the slot machine 1 or the change button 14 is pressed.

Subsequently, on the basis of FIG. 3, an example of symbols drawn on the outer circumferential face of each of the reels 5L, 5C, and 5R and variably displayed through the display windows 10L, 10C, and 10R of the lower image display panel 6 during the game while being scrolled will be described. FIG. 3 is a pattern diagram showing a row of symbols drawn on the outer circumferential faces of each of the reels 5L, 5C, and 5R, respectively.

On the outer circumferential face of each of the left reel 5L, the center reel 5C and the right reel 5R, 22 symbols each are drawn. The row of each symbol is constituted as combination of symbols of “BONUS7”, “BLUE7”, “BELL”, “CHERRY”, “STRAWBERRY”, “PLUM”, “ORANGE”, and “APPLE”. As shown in FIG. 3, on each of the reels 5L, 5C, and 5R, the predetermined types of symbols are arranged in a predetermined order, respectively.

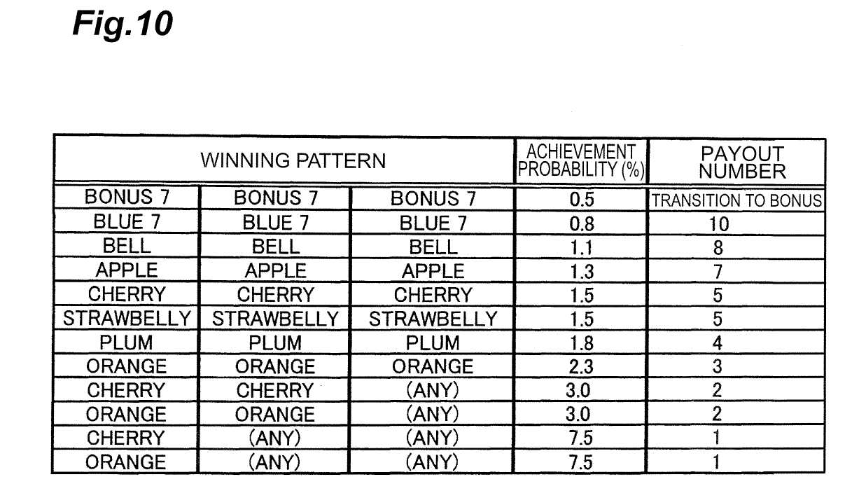

In case of “BLUE7”, “CHERRY”, “STRAWBERRY”, “PLUM”, “ORANGE”, and “APPLE”, when three of them are displayed in the stopped state on the winning line L, the number of credits of predetermined payout is added to the credits owned by the player (See FIG. 10). Further, in case of “CHERRY” and “ORANGE”, even when one or two of them are displayed in the stopped state on the winning line L, the number of credits of the predetermined payout is added as the credits owned by the player according to the number (See FIG. 10).

Moreover, “BONUS7” is a bonus game trigger (the symbol to move to a bonus game). That is, when three “BONUS7” are displayed in the stopped state on the winning line L, the game moves to the bonus game, and the bonus game can be played. Besides, the bonus game executed in the slot machine 1 according to the embodiment is a free game (game which can be played for the predetermined number of times without betting), but it may be any game which moves to a playing state advantageous to the player than the base game.

Here, the paying state advantageous to the player is a state where more gaming media can be obtained than the state of playing a base game, a state where the gaming media can be obtained with a higher probability than the state of playing a base game, or a state where the consumed number of gaming media is smaller than the state of playing a base game. Specifically, there is a selection-type bonus game in which options with which payouts are associated are displayed on the lower image display panel 6 so that the player can choose one of the displayed options other than the free game.

Further, the row of symbols drawn on each of the reels 5L, 5C, and 5R shown in FIG. 3 is scroll-displayed from up to down in the display windows 10L, 10C, and 10R with rotation of the reels 5L, 5C, and 5R when the spin button 13 is pressed to start the game after the 1-BET button 16 or the maximum BET button 17 is pressed. Then, after a predetermined time has elapsed, they are displayed in the stopped state in the display windows 10L, 10C, and 10R with stop of rotation of the reels 5L, 5C, and 5R. Moreover, various winning patterns (See FIG. 10) are set in advance on the basis of combinations of the respective symbols, and when the combination of symbols corresponding to the winning pattern comes to stop on the winning line L, payout corresponding to the stopped pattern is added to the credits owned by the player.

Besides, when the pattern of “BONUS7”, which is a bonus game trigger, is achieved, credits are not added but the bonus game is generated (See FIG. 10).

Next, configuration relating to a control system of the slot machine 1 according to the embodiment will be described on the basis of FIG. 4. FIG. 4 is a block diagram schematically showing the control system of the slot machine 1 according to the embodiment.

As shown in FIG. 4, the control system of the slot machine 1 basically comprises a motherboard 40 and a gaming board 50.

First, the gaming board 50 will be described. The gaming board 50 comprises a CPU 51, a ROM 55 and a boot ROM 52 connected to each other by an internal bus, a card slot 53S corresponding to a memory card 53 and an IC socket 54S corresponding to a GAL (Generic Array Logic) 54.

The memory card 53 comprises a non-volatile memory such as a compact flash (registered trademark) and stores a game program and a game system program. The game program includes a lottery program. The lottery program is a program to determine the symbols on each reel 5L, 5C, and 5R displayed in the stopped state on the winning line L (code No. corresponding to the symbols). The lottery program includes data for weighting symbols corresponding to each of a plurality of payout rate types (80%, 84%, and 88%, for example). The symbol weighting data is data showing correspondence between each symbol code No. (See FIG. 3) and one or a plurality of random number values belonging to a predetermined numerical value range (0 to 255) for each of the three reels 5L, 5C, and 5R. That is, one or plural random number values are associated with one symbol code No., and when the random number is extracted by lottery, the symbol specified by the random number value is displayed in the stopped state.

The payout rates are determined on the basis of data for setting payout rate outputted from the GAL 54, and a lottery is drawn on the basis of the symbol weighting data corresponding to this payout rate.

Also, the card slot 53S is constructed so that the memory card 53 is removable and connected to the motherboard 40 via an IDE bus. Therefore, by removing the memory card 53 from the card slot 53S, writing another game program and game system program in the memory card 53 and inserting the memory card 53 into the card slot 53S, the type or contents of the game played on the slot machine 1 can be changed. Also, by replacing the memory card 53 storing one game program and game system program by the memory card 53 storing another game program and game system program, the type and contents of the game played on the slot machine 1 can be changed.

The game program includes a program relating to game progress and programs for generating a bonus game and so on. Also, the game program includes image data and sound data outputted during the game and image data and sound data as data for notification.

The GAL 54 is a type of PLD having an OR fixed array structure. The GAL 54 is provided with a plurality of input ports and output ports, and when predetermined data is inputted to the input port, data corresponding to the data is outputted from the output port. The data outputted from the output port is the above-mentioned data for setting payout rate.

Also, the IC socket 54S is constructed so that the GAL 54 is removable from it and connected to the motherboard 40 via a PCI bus. Therefore, by pulling out the GAL 54 from the IC socket 54S, rewriting the program stored in the GAL 54 and mounting the GAL 54 to the IC socket 54S, the data for setting payout rate outputted from the GAL 54 can be changed. Also, by replacing the GAL 54 by another GAL 54, the data for setting payout rate can be changed.

The CPU 51, the ROM 55 and the boot ROM 52 connected to each other via the internal bus are connected to the motherboard 40 via the PCI bus. The PCI bus transmits signals between the motherboard 40 and the gaming board 50 and supplies power from the motherboard 40 to the gaming board 50. In the ROM 55, country identification information and an authentication program are stored. In the boot ROM 52, a preliminary authentication program and a program (boot code) and the like for the CPU 51 to start the preliminary authentication program are stored.

The authentication program is a program to authenticate the game program and the game system program (falsification check program). The authentication program is written along falsification check procedures of the game program and the game system program to be covered by an authentication fetch process. The preliminary authentication program is a program to authenticate the above-mentioned authentication program, and the authentication program to be covered by the authentication process is written along falsification check procedure.

Next, the motherboard 40 will be described. The motherboard 40 is constituted using a general-purpose motherboard in the market (print wiring board implemented with basic parts of a personal computer) and comprises the main CPU 41, the ROM 42, the RAM 43 and the communication interface 44.

The ROM 42 comprises a memory device such as a flash memory and stores programs such as BIOS executed by the main CPU 41 and permanent data. When BIOS is executed by the main CPU 41, predetermined initialization process of peripheral devices is executed and the fetch process of the game program and the game system program stored in the memory card 53 is started through the gaming board 50. Incidentally, in the present invention, the ROM 42 may be rewritable or not.

The RAM 43 stores data and programs used when the main CPU 41 is operated. Also, the RAM 43 can store the authentication program to be read out through the gaming board 50, the game program and the game system program as well as various information including the number of credits currently owned by the player.

The communication interface 44 is a communication device for communication with a server installed in a gaming shop through a communication line.

Also, to the motherboard 40, a main body PCB 60 and a door PCB 80, which will be described later, are connected via USB, respectively. Moreover, to the motherboard 40, a power unit 45 is connected. When power is supplied from the power unit 45 to the motherboard 40, the main CPU 41 of the motherboard 40 is started, and the CPU 51 is started by power supplied to the gaming board 50 via the PCI bus.

To the main body PCB 60 and the door PCB 80, equipment and devices for generating input signals to be inputted to the main CPU 41 and equipment and devices whose operation is controlled by control signals outputted from the main CPU 41 are connected. The main CPU 41 executes the game program and the game system program stored in the RAM 43 on the basis of the input signal inputted to the main CPU 41. Further, by a predetermined calculation process, the result is stored in the RAM 43 and control signals are sent to each of the equipment and devices as a control process for each of the equipment and devices.

To the main body PCB 60, the lamp 35, the sub CPU 61, a hopper 66, a coin detecting portion 67, a graphic board 68, the speaker 28 as an output device, the touch panel 11, the bill identifier 22, the ticket printer 30, the card reader 31, the key switch 33S and the data display 32 are connected. The lamp 35 is lighted in a predetermined pattern on the basis of the control signal outputted from the main CPU 41.

The sub CPU 61 is to control rotation and stop of the reels 5L, 5C, and 5R. To the sub CPU 61, a motor driving circuit 62 provided with an FPGA (Field Programmable Gate Array) 63 and a driver 64 is connected. The FPGA 63 is an electronic circuit such as programmable LSI and functions as a control circuit for stepping motors 70L, 70C, and 70R. The driver 64 functions as an amplifier circuit of a pulse inputted to the stepping motors 70L, 70C, and 70R. To the motor driving circuit 62, the stepping motors 70L, 70C, and 70R for rotating each reel 5L, 5C, and 5R are connected. The stepping motors 70L, 70C, and 70R are 1-2 phase excitation method stepping motors.

Note that, in the present invention, the excitation method of the stepping motors 70L, 70C, and 70R is not particularly limited but a 2-phase excitation method, a 1-phase excitation method or the like may be employed. Also, in place of the stepping motor, a DC motor may be employed. If the DC motor is to be employed, a deviation counter, a D/A converter and a servo amplifier are connected to the sub CPU 61 in this order and the DC motor is connected to the servo amplifier. The rotation position of the DC motor is detected by a rotary encoder, and the current rotation position of the DC motor is supplied as data from the rotary encoder to the deviation counter.

Also, to the sub CPU 61, an index detecting circuit 65 and a position change detecting circuit 71 are connected. The index detecting circuit 65 is to detect positions (a reference point, for example) of the reels 5L, 5C, and 5R during rotation and moreover capable of detection of synchronization loss of the reels 5L, 5C, and 5R.

The position change detecting circuit 71 detects change in stop positions of the reels 5L, 5C, and 5R after rotation of the reels 5L, 5C, and 5R is stopped. For example, the position change detecting circuit 71 detects the change in the stop positions of the reels 5L, 5C, and 5R when the stop positions are changed so that the combination of symbols be the winning mode forced by a player or the like, though the combination of the symbols is not actually the winning mode.

The hopper 66 is placed inside the cabinet 2 and pays out the predetermined number of coins from the coin payout slot 23 into the coin tray 24 on the basis of the control signal outputted from the main CPU 41. The coin detecting portion 67 is provided inside the coin payout slot 23 and outputs an input signal to the main CPU 41 when payout of the predetermined number of coins from the coin payout slot 23 is detected.

The graphic board 68 controls image display on the upper image display panel 27 and the lower image display panel 6 as an output device on the basis of the control signal outputted from the main CPU 41. On the game setting portion 7 of the lower image display panel 6, display relating to the first game setting portion 7A to the third game setting portion 7C is made, and the currently set number of times (one in the initial setting) stored in the RAM 43 is displayed (See FIG. 2). Also, the credit number display portion 8 displays the number of credits owned by the player and stored in the RAM 43. Further, the payout number display portion 9 of the lower image display panel 6 displays the number of paid out credits for payout.

Here, the graphic board 68 is provided with a VDP (Video Display Processor) for generating image data on the basis of the control signal outputted from the main CPU 41, a video RAM for temporarily storing image data generated by the VDP and the like. The image data used by the VDP for generation of the image data is included in the game program read out of the memory card 53 and stored in the RAM 43.

Further, the bill identifier 22 identifies adequacy of bills and the bar-coded tickets 25 and receives legitimate bills and bar-coded tickets 25 into the cabinet 2. When the legitimate bill is received, the bill identifier 22 outputs an input signal to the main CPU 41 on the basis of the amount of the bill. Also, an input signal is outputted to the main CPU 41 on the basis of the number of coins recorded in the legitimate bar-coded ticket 25. Then, the main CPU 41 stores the amount of the bill and the number of credits corresponding to the bar-coded ticket 25 transmitted by the input signals in the RAM 43.

The ticket printer 30 prints a barcode with coded data such as the number of credits stored in the RAM 43, date, the identification number of the slot machine 1 and the like on a ticket on the basis of the control signal outputted from the main CPU 41 and outputs it as the bar-coded ticket 25.

Also, the card reader 31 reads out data from the smart card and sends it to the main CPU 41 and writes data in the smart card on the basis of the control signal from the main CPU 41. The key switch 33S is provided at the key pad 33 and outputs a predetermined input signal to the main CPU 41 when the key pad 33 is operated by the player. The data display 32 displays data read out by the card reader 31 and data inputted by the player via the key pad 33 on the basis of the control signal outputted from the main CPU 41.

On the other hand, to the door PCB 80, the control panel 20, the reverter 21S, the coin counter 21C and a cold cathode tube 81 are connected. To the control panel 20, a spin switch 13S corresponding to the spin button 13, a change switch 14S corresponding to the change button 14, a CASHOUT switch 15S corresponding to the CASHOUT button 15, a 1-BET switch 16S corresponding to the 1-BET button 16 and a maximum BET switch 17S corresponding to the maximum BET button 17 are provided. Each switch outputs an input signal to the main CPU 41 when the corresponding button is operated by the player.

The coin counter 21C is provided inside the coin slot 21 and identifies adequacy of the coin inputted by the player into the coin slot 21. Those other than legitimate coins are ejected from the coin payout slot 23. Also, the coin counter 21C outputs an input signal to the main CPU 41 when a legitimate coin is detected.

The reverter 21S operates on the basis of the control signal outputted from the main CPU 41 and sorts out the coins recognized by the coin counter 21C as legitimate coins to a cash box (not shown) arranged in the slot machine 1 or to the hopper 66. That is, when the hopper 66 is filled with coins, legitimate coins are sorted by the reverter 21S to the cash box. On the other hand, when the hopper 66 is not filled with coins, the legitimate coins are sorted to the hopper 66.

The cold cathode tube 81 is arranged on the back face sides of the lower image display panel 6 and the upper image display panel 27 to function as a backlight. In addition, the cold cathode tube 81 is lighted on the basis of the control signal outputted from the main CPU 41.

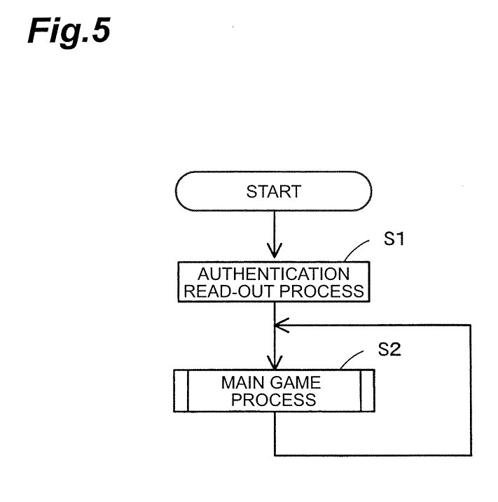

Subsequently, a main control program executed in the slot machine 1 according to the embodiment will be described in detail referring to the attached drawings. FIG. 5 is a flowchart of the main control program.

Here, it is supposed that the memory card 53 has been already inserted to the card slot 53S of the gaming board 50 and the GAL 54 is mounted to the IC socket 54S in the slot machine 1.

First, when a power switch is turned on (power on) at the power unit 45, the motherboard 40 and the gaming board 50 are started respectively and an authentication read-out process (S1) is executed. In this authentication read-out process (S1), the motherboard 40 and the gaming board 50 carry out separate processes individually.

That is, at the gaming board 50, the CPU 51 reads out the preliminary authentication program stored in the boot ROM 52 and executes preliminary authentication to confirm and certify that the authentication program has not been tampered in advance before taking-in to the motherboard 40 according to the read-out preliminary authentication program.

On the other hand, at the motherboard 40, the main CPU 41 executes BIOS stored in the ROM 42, extracts compressed data incorporated in BIOS to the RAM 43 to execute BIOS extracted to the RAM 43 and to diagnose and initialize various peripheral devices.

After that, the main CPU 41 reads out the authentication program stored in the ROM 55 and executes authentication to confirm and certify that the game program and the game system program stored in the memory card 53 inserted into the card slot 53S has not been tampered.

If this authentication process is finished normally, the main CPU 41 writes the game program and the game system program, which were the subject of authentication (having been authenticated), in the RAM 43 and obtains data for setting payout rate and country identification information.

After the above-mentioned process, the main CPU 41 ends the authentication read-out process (S1).

And at S2, the main CPU 41 sequentially reads out the game program and the game system program authenticated in the authentication read-out process (S1) from the RAM 43 and executes them and carries out a main game process. By executing this main game process (S2), a game in the slot machine 1 according to the embodiment is played. The main game process (S2) is repeatedly executed as long as power is supplied to the slot machine 1.

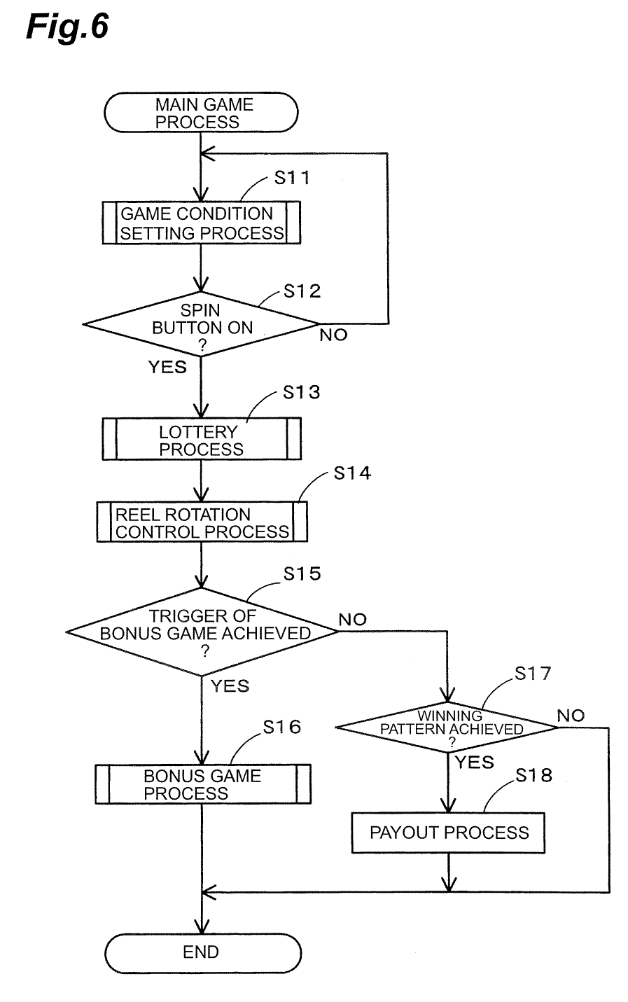

Next, a main game process program executed in the above main game process (S2) will be described on the basis of FIG. 6. FIG. 6 is a flowchart of the main game process program in the slot machine according to the embodiment. Each program shown by flowcharts in FIGS. 6, 7, 9, 11 and 15 is stored in the ROM 42 and the RAM 43 provided at the slot machine 1 and executed by the main CPU 41.

When the main game process (S2) is started, the main CPU 41 executes a predetermined initial setting and then, executes a game condition setting process (S11) for setting various conditions (the numbers of bets, number of times to be played) relating to the game to be executed this time. Since the game condition setting process (S11) will be described later in detail referring to the attached drawings, explanation will be omitted here.

By the game condition setting process (S11), game conditions such as the number of bets for the winning line L, the number of times of game to be played as a single set if games and so on are set and then, the process moves to S12.

At S12, the main CPU 41 determines if the spin button 13 has been turned on or not. Specifically, the main CPU 41 determines if the input signal outputted from the spin switch 13S when the spin button 13 is pressed has been received or not.

If it is determined that the spin button 13 has not been turned on (S12: NO), the main CPU 41 returns the process to S11. On the other hand, if it is determined that the spin button 13 has been turned on (S12: YES), the number of credits as consideration is subtracted from the number of owned credits and the process moves to S13.

At S13, the main CPU 41 executes a lottery process, which will be described later. At the lottery process (S13), the main CPU 41 executes a lottery program stored in the RAM 43 and determines code No. at the time of stop of each of the reels 5L, 5C, and 5R. At this time, a lottery is drawn for the number of times set at the game condition setting process (S11) and the combination of symbols displayed in the stopped state is determined for the number of times. Since the lottery process will be described later in detail, the explanation will be omitted here.

Note that, in the embodiment, an example to determine one winning pattern from a plurality of winning pattern types by determining the combination of symbols displayed in the stopped state is described, but in the present invention, it may be configured such that one winning pattern chosen from plural types of winning patterns is determined first by lottery and then, the combination of symbols in the stopped state displayed is determined on the basis of the above winning pattern.

Subsequently, at S14, the main CPU 41 carries out a reel rotation control process. The reel rotation control process is a process to stop rotation of each reel 5L, 5C, and 5R so that the combination of symbols determined at the lottery process (S13) is displayed in the stopped state on the winning line L after the rotation of all the reels 5L, 5C, and 5R is started. Since this process will be described later in detail using the attached drawings, detailed explanation will be omitted.

Next, at S15, the main CPU 41 determines if the bonus game trigger has been achieved or not, that is, the three symbols of “BONUS7” are displayed in the stopped state on the winning line L of the display windows 10L, 10C, and 10R or not.

As a result, if it is determined that the bonus game trigger is achieved (S15: YES), the main CPU 41 reads out the program to execute the bonus game from the RAM 43 and then executes a bonus game process, which will be described later (S16). After the bonus game process (S16) is finished, the main CPU 41 ends the main game process.

Besides, the bonus game process will be described later in detail using the attached drawings.

On the other hand, if it is determined that the bonus game trigger is not achieved (S15: NO), it is subsequently determined if any winning pattern is achieved by a combination of symbols displayed in the stopped state on the winning line L or not (S17).

As a result, if it is determined that some winning pattern has been achieved (S17: YES), the main CPU 41 executes a payout process to add credits according to the payout of the achieved pattern to the credits owned by the player (S18). In addition, the added credits are paid out as coins according to the number of credits (one credit corresponds to one coin) by pressing the CASHOUT button 15. Also, they can be paid out by the bar-coded ticket 25. After the payout process (S18) is finished, the main game process is ended. Alternatively, if it is determined that no winning pattern has been achieved (S17: NO), the main game process is ended at this point.

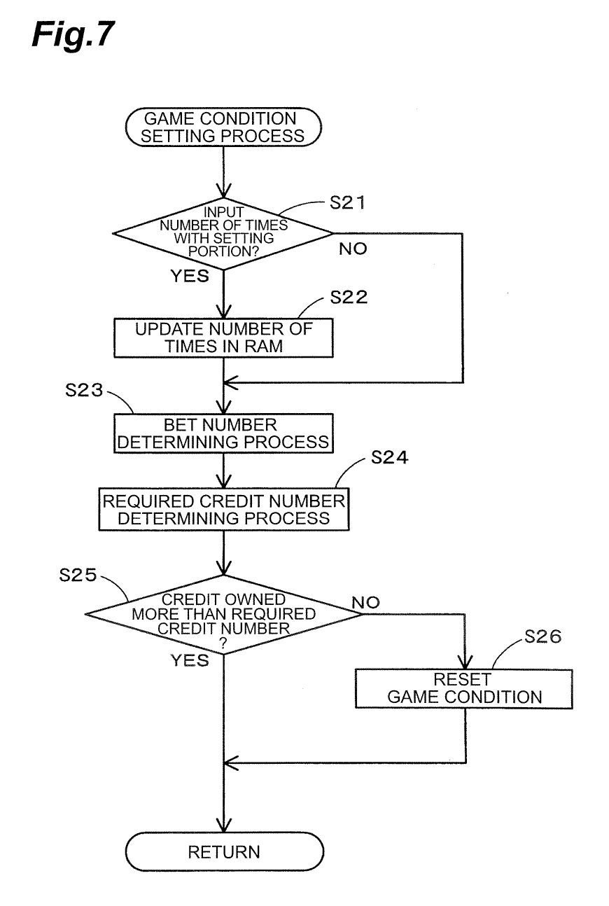

Next, the game condition setting process program executed at S11 in the main game process program will be described in detail referring to the attached drawings. FIG. 7 is a flowchart of the game condition setting process program.

When the process moves to SI1 in the main game process program, the main CPU 41 starts execution of the game condition setting process program.

At the game condition setting process (SI1), first, the main CPU 41 carries out the initial setting (setting of the number of times to one and the number of bets to “one”, for example) and then, determines if the game setting portion 7 is operated or not (S21). Specifically, at S21, the main CPU 41 determines if the first game setting portion 7A to the third game setting portion 7C has been operated or not on the basis whether the touch panel 11 corresponding to the lower image display panel 6 on which the first game setting portion 7A to the third game setting portion 7C are displayed is pressed or not.

If any of the first game setting portion 7A to the third game setting portion 7C has been operated in some way (S21: YES), the number-of-times data stored in the RAM 43 is updated on the basis of the operation (S22). For example, if the second game setting portion 7B is operated once, the initial setting of “number of times to be played: one” is updated to “number of times to be played: five” corresponding to the second game setting portion 7B. If the second game setting portion 7B is further operated, “five” is added to the above number of times to be updated to “number of times to be played: 10”. In this regard, in case of the first game setting portion 7A, “one” is added to the number of times, while in case of the third game setting portion 7C, “10” is added. After the number-of-times data stored in the RAM 43 is updated on the basis of the operation of the game setting portion 7, the process moves to S23. Here, at this time, with the update of the number-of-times data stored in the RAM 43, the number of times being displayed on the number-of-times display portion 7D is also updated.

On the other hand, if no operation is made to the first game setting portion 7A to the third game setting portion 7C (S21: NO), the process directly moves to S23.

At S23, a bet number determining process to determine the number of bets for the winning line L in this game is executed. At the bet number determining process (S23), the main CPU 41 determines the number of bets for the winning line L on the basis of the operation of the 1-BET button 16 and the maximum BET button 17. Specifically, on the basis of the signal sent from the 1-BET switch 16S and the maximum BET switch 17S disposed on the 1-BET button 16 and the maximum BET button 17, operation of the 1-BET button 16 and the maximum BET button 17 is detected, and the number of bets for the winning line L is determined on the basis of the operation contents. After the determined number of bets is stored in the RAM 43 as the bet number data, the process moves to S24.

Subsequently, at S24, a required credit number determining process for determining the number of credits required for execution of the game for one set is carried out. That is, the main CPU 41 calculates the number of credits required to execute the game for the set number of times with the set number of bets.

Here, the required credit number determining process (S24) will be described in detail. In the required credit number determining process, first, the main CPU 41 reads out the number-of-times data and the bet number data from the RAM 43 and calculates the reference required credit number from the product of the number of times shown by the number-of-times data and the bet number shown by the bet number data.

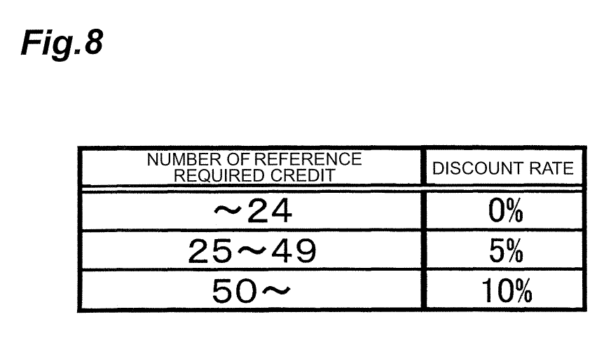

After calculation of the reference required credit number, the main CPU 41 reads out a discount rate table shown in FIG. 8 and determines a discount rate. Then, on the basis of the discount rate determined in accordance with the discount rate table, a value obtained by discounting the reference required credit number is calculated as the required credit number.

The calculation of the required credit number in the required credit number determining process (S24) will be described with a specific example. Suppose, for example, that the number of times is set to “10 times” and the number of bets to “5”, the reference required credit number becomes “50”. Then, the discount rate of “10%” is set on the basis of the discount rate table shown in FIG. 8. Therefore, in this case, on the basis of the “reference required credit number×(100(%)−discount rate)”, “45” as 90% of the reference required credit number “50” is calculated as the required credit number.

Alternatively, if the number of times is set to “7 times” and the number of bets to “4”, the reference required credit number becomes “28”. Then, on the basis of the discount rate table shown in FIG. 8, the discount rate of “5%” is set. Therefore, in this case, on the basis of the “reference required credit number×(100(%)−discount rate)”, “26.6” as 95% of the reference required credit number “28” is calculated. In this case, the fractional part is rounded up to have the required credit number of “27”. The rounding-up method of the fractional part may be rounded off or to the nearest.

When the required credit number on the basis of the set number of times and the number of bets is calculated at S24, the main CPU 41 compares the credit number currently owned by the player with the calculated required credit number and determines if the credit number larger than the required credit number is owned or not (S25).

If the credit number larger than the required credit number is owned (S25: YES), since the required credit number can be paid as consideration of the game, the game condition setting process is ended. On the other hand, if the credit number larger than the required credit number is not owned (S25: NO), the required credit number can not be paid as the consideration of the game and the setting of the number of times and bet numbers is wrong, these game conditions (the number of times to be played, the number of bets) are reset and the initial setting (number of times to be played: one, bet number: one) is set. After the game conditions are reset, the game condition setting process is ended.

Here, as mentioned above, after the game condition setting process is finished, the game is started by operation of the spin button 13 (S12: YES). Therefore, when the game is to be played under the conditions set by the game condition setting process, the player can play the game under the game condition only by operating the spin button 13. On the other hand, if the set condition should be modified by reset of the game conditions or the like, the game condition desired by the player and capable of game execution can be set by operation of the game setting portion 7 and the like without operating the spin button 13.

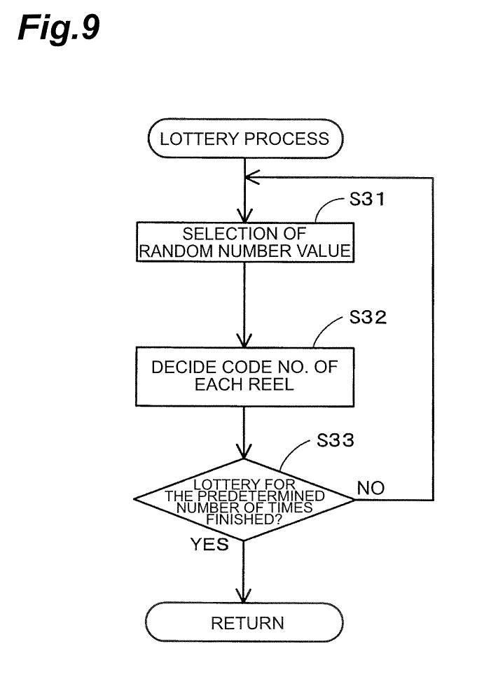

Next, the lottery process program executed at S13 of the main game process program will be described using FIG. 9. FIG. 9 is a flowchart of the lottery process program.

When execution of the lottery process program is started, first, the main CPU 41 executes a program for generating a random number included in the lottery program at S31 to select a random number value corresponding to each of the three reels 5L, 5C, and 5R from a numerical value range of 0 to 255. In the embodiment, a case where the random number is generated on the program (the case where so-called software random number is used) will be described. However, in the present invention, a random number generator may be provided to extract a random number from the random number generator (using a so-called hardware random number).

Next, at S31, the main CPU 41 refers to the symbol weighting data corresponding to the data for setting payout rate outputted from the GAL 54 and stored in the RAM 43 and further determines code No. of each of the reels 5L, 5C, and 5R (See FIG. 3) on the basis of the selected three random number values (S32). After the determined code No. of each of the reels 5L, 5C, and 5R is stored in the RAM 43, the process moves to S33.

Here, since the code No. of each of the reels 5L, 5C, and 5R corresponds to the code No. of the symbol displayed in the stopped state on the winning line L, the winning pattern in this game is determined when the main CPU 41 determines the code No. of each of the reels 5L, 5C, and 5R. For example, if the code No. of each of the reels 5L, 5C, and 5R is determined to “00”, and “00”, respectively, the main CPU 41 is considered to determine the winning pattern as “BONUS7”.

Incidentally, the reel rotation control process, which will be described later, is carried out on the basis of the code Nos. of the reels stored in the RAM 43.

After the code No. of each reel 5L, 5C, and 5R is determined at S32, the main CPU 41 determines if a lottery has been drawn (S33) for the number of times set by the game condition setting process (S11). The main CPU 41 makes determination on the basis whether the code No. of the reel for the number of times shown by the number-of-times data stored in the RAM 43 is stored in the RAM 43 or not.

If the lottery has been drawn for the number of times (S33: YES), the lottery process is finished. On the other hand, if the drawing has not been finished for the number of times (S33: NO), the process returns to S31, and the selection of the random number value (S31) and determination of code No. for each of the reels 5L, 5C, and 5R are carried out.

Here, the winning pattern and its payout in the cases of base game and the bonus game using the reels 5L, 5C, and 5R in the slot machine 1 will be described referring to FIG. 10. FIG. 10 is a table showing the winning patterns and an achievement probability and payout of each pattern when a game is played using the reels 5L, 5C, and 5R.

Here, the payouts shown in FIG. 10 show the payout when the number of bets is “one”. Therefore, if the number of bets is “one”, the value of the payout shown in FIG. 10 is added to the credit, while if the number of bets is “two” or more, the value obtained by multiplying the value of the payout shown in FIG. 10 by the number of bets is added to the credit.

Also, the achievement probability of each pattern shown in FIG. 10 shows the case where the payout rate other than the bonus game is 88%. The achievement probability shown in the figure shows a probability of achievement of the pattern concerned when the code No. of each reel 5L, 5C, and 5R is determined on the basis of the three random number values referring to the symbol weighting data. That is, the random number value is not associated with each pattern.

For example, the achievement probability of the “BONUS7”, which is a bonus game trigger is 0.5%. When the pattern of the “BONUS7” is won, the three symbols of the “BONUS7” are displayed in the stopped state on the winning line, and a bonus game is generated. In the bonus game, a free game is executed for the number of times determined by lottery.

Also, the achievement probability of the “BLUE7” is 0.8%. If this pattern is achieved, the three symbols of the “BLUE7” are displayed in the stopped state on the winning line L, and 10 credits per bet are paid out as a payout.

In addition, the achievement probability of “BELL” is 1.1%. If this pattern is achieved, the three symbols of the “BELL” are displayed in the stopped state on the winning line L, and 8 credits per bet are paid out as a payout.

The achievement probability and the number of payout are similarly set for each combination shown in FIG. 10. However, if a combination of symbols not constituting any pattern combination shown in FIG. 10 is displayed in the stopped state, it means lost and no credit will be paid out.

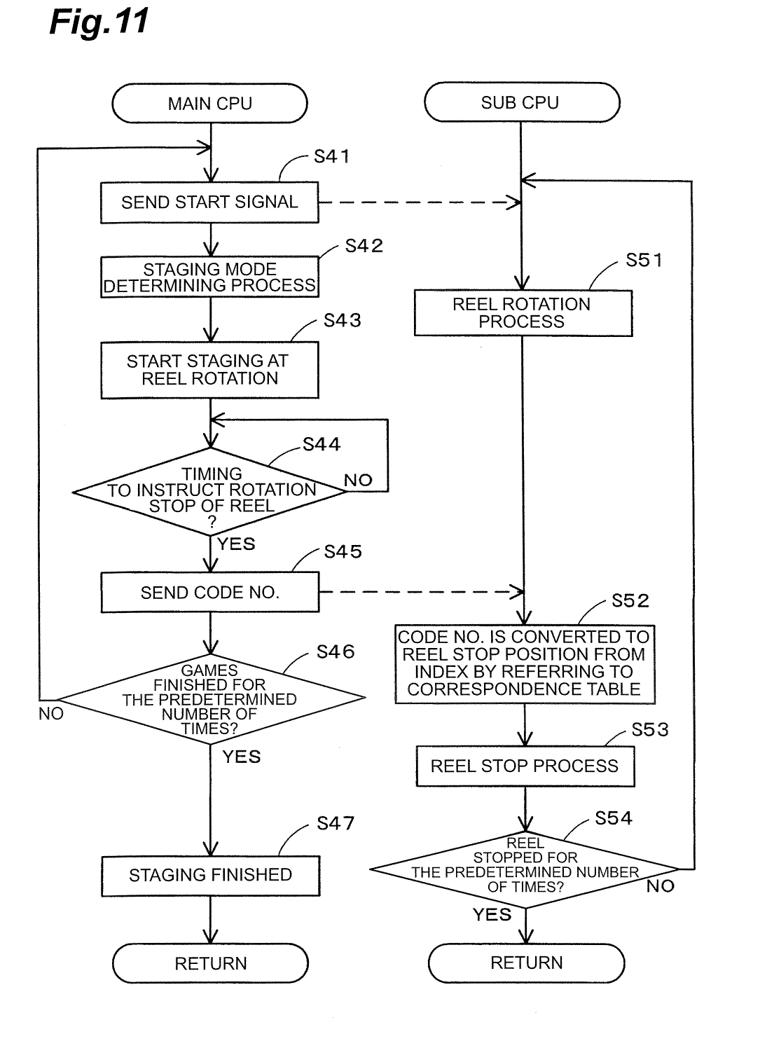

Next, the reel rotation control process program executed at S14 of the main game process program will be described using FIG. 11. FIG. 11 is a flowchart of the reel rotation control process program. Here, this process is a process executed between the main CPU 41 and the sub CPU 61.

First, at S41, the main CPU 41 sends a start signal to start rotation of the reel to the sub CPU 61. When the sub CPU 61 receives the start signal from the main CPU 41, it carries out the reel rotation process (S51). In this process, the sub CPU 61 supplies a pulse to the motor driving circuit 62 (See FIG. 4). The pulse outputted from the sub CPU 61 is amplified by the driver 64 and supplied to each of the stepping motors 70L, 70C, and 70R. As a result, each of the stepping motors 70L, 70C, and 70R is rotated and with the rotation, each of the reels 5L, 5C, and 5R is rotated. The 1-2 phase excitation type stepping motors 70L, 70C, and 70R have a step angle of 0.9°, and the number of steps per rotation is 400. Therefore, when 400 pulses are supplied to the stepping motors 70L, 70C, and 70R, the reels 5L, 5C, and 5R are rotated once.

At start of rotation of the reels 5L, 5C, and 5R, the sub CPU 61 supplies a pulse with a low frequency to the motor driving circuit 62 and gradually increases the frequency of the pulse. With that, the rotation speed of the reels 5L, 5C, and 5R is increased. And when a predetermined time has elapsed, the pulse frequency is made constant. As a result, the reels 5L, 5C, and 5R are rotated at a constant speed.

Note that, with the code No. corresponding to a symbol drawn on the outer circumferential face of each of the reels 5L, 5C, and 5R, the reference point of each reel and the number of steps on the basis of the reference point are associated, respectively. Therefore, when the reference point is detected, the pulses corresponding to the step number are supplied to the motor driving circuit 62, and after that, the supply of pulses is stopped so that a predetermined symbol can be stopped on the winning line L.

At S41, after the start signal is sent to the sub CPU 61, the main CPU 41 executes a staging mode determining process (S42) for determining a staging mode which determines a staging mode (mode such as display of images on the lower image display panel 6 and output of sound from the speaker 28 and the like) for the game of this single set (the number of times set by the game condition setting process).

In this staging mode determining process (S42), the main CPU 41 determines the total required time for one set of game to be finished and a required time for game constituting the single set (hereinafter referred to as a required time per game) on the basis of the set number of times to be played. Moreover, the main CPU 41 executes a process to determine staging contents to be performed during execution of a single set of games.

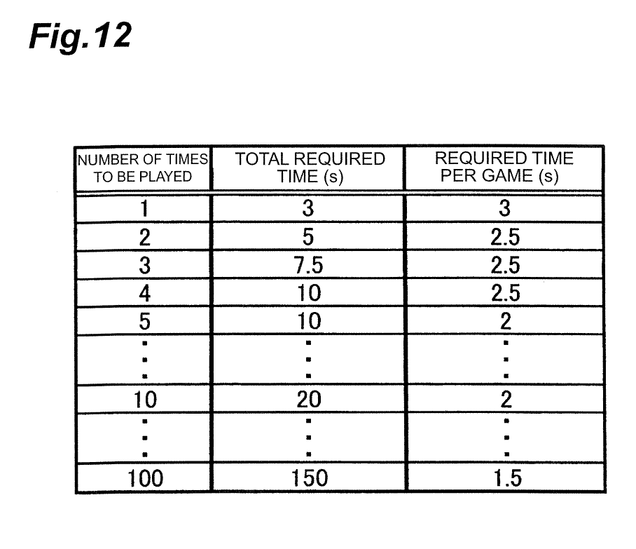

Here, this staging mode determining process (S42) will be described in detail. When the process moves to the staging mode determining process (S42), the required time per game, which is a required time for a single game, and a time required for the game for the number of times to be played, that is, the total required time, which is the time required for the game of the single set, are determined on the basis of the number of times set by the game condition setting process (S11). That is, the main CPU 41 reads out the number-of-times data from the RAM 43 and sets the required time per game and the total required time by referring to a required time table shown in FIG. 12.

As shown in FIG. 12, the required time table sets the required time per game and the total required time for one to 100 games, respectively, which can be set as the number of times to be played in the slot machine 1. When the required time per game is focused, the required time per game is set to be shorter as the number of times to be played is increased. For example, in the case of “number of times to be played: one”, the required time per game is “3.0 (s)”, while if “number of times to be played: five” is set, the required time per game is reduced to “2.0 (s)”. Moreover, if the number of times to be played is set to 100 times, the required time per game is “1.5 (s)”.

In this way, the required time per game is determined according to the number of times to be played for one set and on the basis of the required time per game, the total required time is determined. That is, the total required time is determined by the product of the required time per game and the number of times to be played. For example, if “number of times to be played: five times” is set, the required time per game is “2.0 (s)” and the total required time is “10.0 (s)”, which is the product of the required time per game and the number of times to be played.

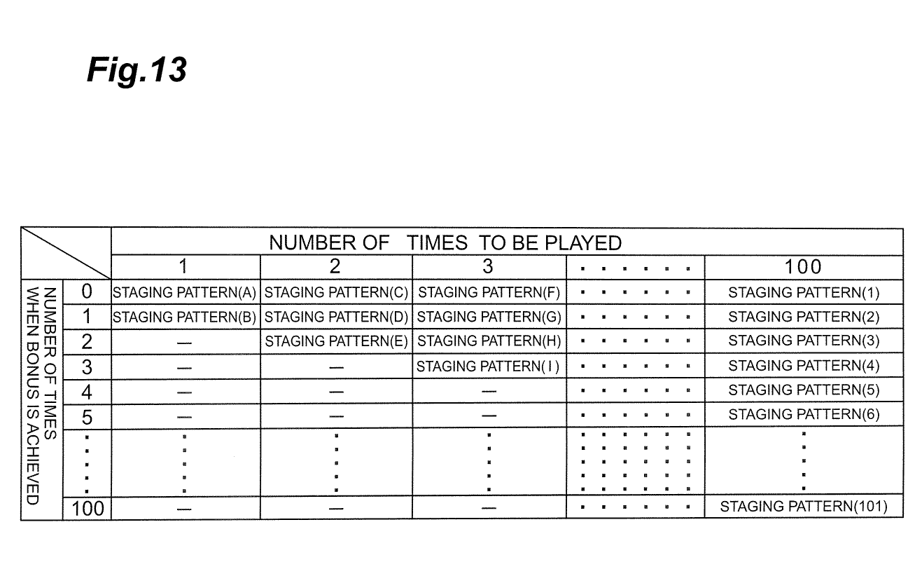

Also, in the staging mode determining process (S42), the staging pattern showing the staging contents is determined on the basis of the number-of-times data and the lottery result for the number of times to be played. Here, the determination of the staging pattern will be described referring to FIG. 13.

In the slot machine 1 according to the embodiment, the staging pattern is determined according to the lottery result for the set number of times to be played. Specifically, different staging patterns are set on the basis of the number of winning times of “BONUS7” in the lottery results for the set number of times to be played.

In this regard, in determining the staging pattern, the staging pattern table shown in FIG. 13 is referred to. In this staging pattern table, the staging pattern for the number of times which can win the pattern of the “BONUS7” (0 to the covered number of times to be played) is specified for each of the number of times (one to 100 times) which can be set. For example, in the case of “number of times to be played: two times”, the number of winning times of the pattern of the “BONUS7” is three patterns of “0 time”, “one time” and “two times”, and the “staging pattern (C)” “staging pattern (D)” and “staging pattern (E)” are specified for each (See FIG. 13).

Also, each of the staging patterns specified in the staging pattern table is constituted by the staging period according to the number of times associated with each other. That is, when a certain number of times to be played is set, the staging pattern associated with that number of times to be played is set so that the staging is provided in the same staging period as the total required time determined on the basis of the number of times and the above required time table.

For example, in the case of the above “number of times to be played: two times”, any of the “staging pattern (C)” “staging pattern (D)” and “staging pattern (E)” associated with that number of times to be played is set to provide staging in the same staging period as the total required time of “5.0 (s)” when the number of times determined by the required time table (See FIG. 12) is two times.

That is, by executing the staging mode determining process (S42), the “staging pattern”, “total required time” and “required time per game” are determined on the basis of the set number of times and the lottery result for the number of times.

Here, the required time table of the slot machine 1 is set so that the larger the number of times to be played is, the shorter the required time per game becomes, and the “required time per game” is determined on the basis of the number of times to be played. Thus, when the number of times to be played is set large, the required time can be made shorter than the case where a single game is played for the same number of times. Owing to this, since the period when the player occupies the slot machine 1 can be reduced, the operating rate of the slot machine 1 can be improved.

Also, by executing the staging mode determining process (S42), the staging period is set on the basis of the set number of times to be played, and the “staging pattern” according to the lottery result for the set number of times to be played is determined. Owing to this, since staging is provided in the “staging pattern” according to the lottery result, the lottery result can be notified from the staging pattern. Moreover, the “staging pattern” concerned is made available for the “total required time” determined from the set number of times to be played. That is, since staging is available for a long period of the “total required time”, diversified staging is made possible. Owing to this, staging which could not be fully realized due to time limitation is made possible, and more diversified staging can be provided effectively. A staging with some story can be an example of such a staging, which could not be fully expressed in a short time and whose staging effect was weak. However, by enabling a staging for a long time, the plot can be depicted in one staging pattern and an attractive story can be used as staging.

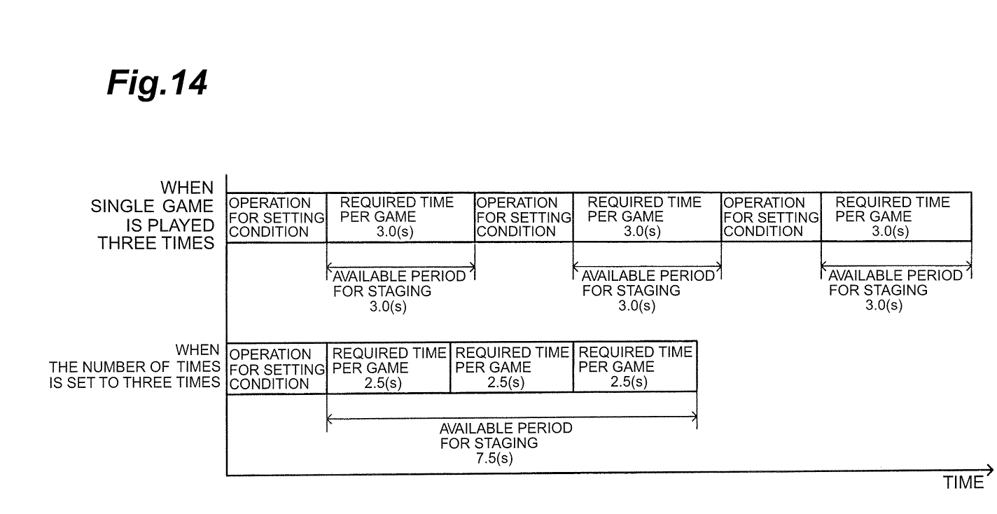

The above point will be described specifically referring to FIG. 14. FIG. 14 is an explanatory view showing the required time and the staging available period for a case where a single game (that is, a game played separately) is 3 times and a case where a game is played by setting the number of times to 3 times.

As shown in FIG. 14, when a single game is played three times, condition setting operation is necessary to set the number of times to be played and the number of bets before playing the respective games. Moreover, since the “number of times to be played” is one, the required time for a single game is “3.0 (s)”. That is, the staging available period is “3.0 (s)” for a single game.

On the other hand, if the number of times to be played is set to 3 times, the condition setting operation may be required only for the first one, and since the number of times to be played is 3 times. Therefore, the required time per game is “2.5 (s)” and the staging available period is “7.5 (s)”, which is three times of the required time per game.

As obvious from FIG. 14, if the number of times to be played is set to 3 times though the same game is played three times in this case, the three times of game playing can be executed in a shorter period. That is, the period when the player occupies the slot machine 1 can be reduced, and the operating rate of the slot machine 1 can be improved.

Also, considering the staging available period, when executed for each game, the staging is provided three times in a short period of “3.0 (s)” as the staging available period. Since the staging for a single game is completed every time and there is a time restriction of “3.0 (s)”, it is difficult to provide diversified staging in this case.

In this regard, when the number of times to be played is set to 3 times, there is a long staging available period of “7.5 (s)”. In this point, though the total sum of the staging periods is shorter than the case of execution at every game, the period available for one staging becomes 2 times or more. That is, it becomes possible to provide staging utilizing the long period, and time restriction is relaxed and diversified staging is made possible. Also, since continuous staging becomes possible without condition setting operation between games, it is possible to attract the player to the staging.

After the staging pattern and the like is determined by the staging mode determining process (S42) in this way, the main CPU 41 starts the staging in the determined staging pattern in S43. And at S44, the main CPU 41 determines if it is a timing to instruct rotation stop of the reel 5L. Here, the timing to instruct rotation stop of the reel 5L is a timing before the “required time per game” set in the staging mode determining process (S42) by the minimum required time to stop rotation of the reel 5L. The minimum required time to stop rotation of the reel 5L is determined in advance.

In addition, if it is determined as the timing not to instruct rotation stop of the reel 5L (S44: NO), the staging at reel rotation is continued. On the other hand, if it is determined as timing to instruct rotation stop of the reels 5L, 5C, and 5R (S44: YES), the main CPU 41 sends the code No. of the reel stored in the RAM 43 to the sub CPU 61 (S45).

In response, when the sub CPU 61 receives the code No. of the reel from the main CPU 41, the sub CPU 61 converts the code No. to the stop position (number of steps) of the reel from the index on the basis of the correspondence table between the number of steps and the code No. stored in the ROM (not shown) provided at the sub CPU 61 (S52).

Next, at S53, the sub CPU 61 executes the reel stop process. In this process, the sub CPU 61 detects the reference point on the circumference of each of the reels 5L, 5C, and 5R, supplies pulses corresponding to the number of steps corresponding to the code No. to the motor driving circuit 62 at the detection timing and then, stops supply of the pulses. Owing to this, the symbol corresponding to the lottery result is displayed in the stopped state on the winning line L of each of the display windows 10L, 10C, and 10R.

After that, at S54, the sub CPU 61 determines if the reel stop process has been executed for the number of times to be played or not. If the process has been executed for the number of times to be played (S54: YES), the reel rotation control process is finished. On the other hand, if the reel stop process has not been executed for the number of times to be played (S54: NO), the process is made to stand by till the start signal from the main CPU 41 is received, and with receiving of the start signal, S51 is executed and the above-mentioned process is repeated.

On the other hand, after the code No. is sent to the sub CPU 61 (S45), the main CPU 41 determines if or not (S46). When the game for the number of times has been finished (S46: YES), the process proceeds to S47 and the staging started at S42 is ended. After the staging is finished, the reel rotation control process is ended. If the game for the number of times has not been finished (S46: NO), the process returns to S41 again and sends the start signal to the sub CPU 61 to start rotation of the reels 5L, 5C, and 5R relating to the next game.

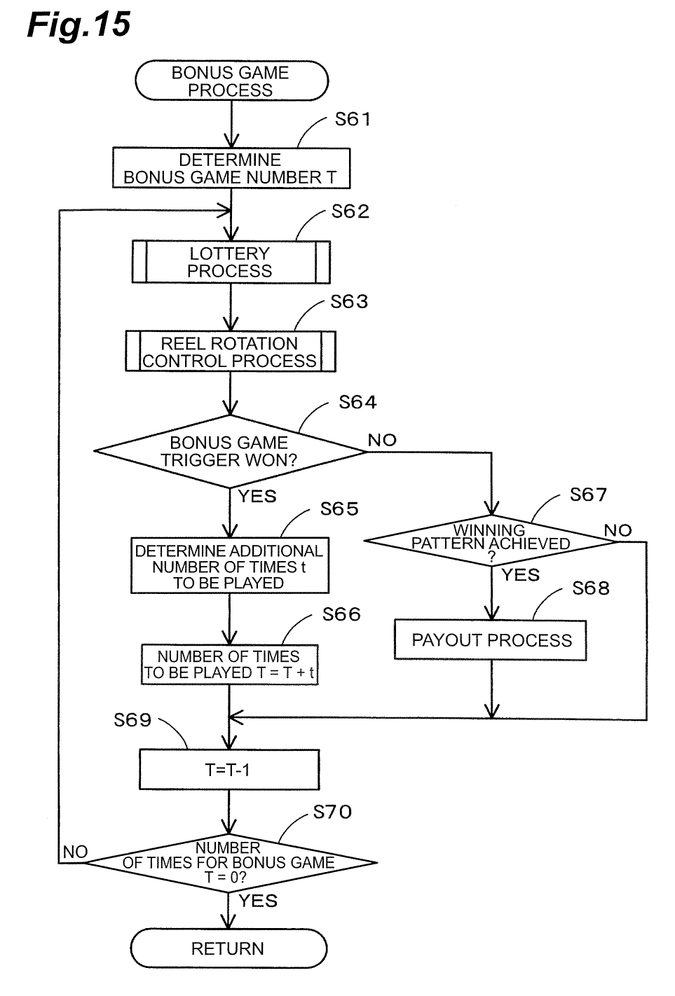

Next, the bonus game process program to be executed in S16 of the main game process program will be described in detail referring to the attached drawings. FIG. 15 is a flowchart of the bonus game process program. Incidentally, this process is executed between the main CPU 41 and the sub CPU 61.

In the bonus game process, first, at S61, the main CPU 41 determines the number of times of the bonus game to any one from 10 to 25 games on the basis of the random number value obtained by executing the random number generating program included in the lottery program stored in the RAM 43. And the main CPU 41 stores the determined number of the bonus games in the RAM 43 as the bonus game number data (hereinafter referred to as the bonus game number T).

Then, the main CPU 41 executes the lottery process (S62) and the reel rotation control process (S63). Here, the lottery process at S62 is substantially the same process as the process described using the above FIG. 9. Also, the reel rotation control process at S63 is substantially the same process as the process described using the above FIG. 11. Since these processes have been already described, the explanation will be omitted here. Besides, the lottery process (S62) and the reel rotation control process (S63) during the bonus game process are executed as the “number of times to be played: one” all the time unlike the above-mentioned lottery process (S13) and the reel rotation control process (S63).

Next, at S64, the main CPU 41 determines if the bonus game trigger is achieved or not, that is, the three symbols of the “BONUS7” are displayed in the stopped state on the winning line L of the display windows 10L, 10C, and 10R.

As a result, if it is determined that the winning pattern of the “BONUS7” is achieved (S64: YES), an additional number of times t of the bonus game is newly determined by lottery (S65), and the determined additional game number t is added to the current bonus game number T (S66). Owing to this, if the bonus game is won during the bonus game, the remaining number of times of the bonus game is increased. Specifically, at the first transition to the bonus game of 20 times, for example, when the bonus game of 17 times is won at the 12th bonus game, the bonus game of 25 times (20 times−12 times+17 times) is played after that. After the additional game number t is added to the bonus game number T, the process moves to S69.

On the other hand, if it is determined that the winning pattern of the “BONUS7” is not achieved (S64: NO), it is subsequently determined if any winning pattern is achieved by combination of symbols displayed in the stopped state on the winning line (S67). As a result, if it is determined that some winning pattern is achieved (S67: YES), the main CPU 41 executes a payout process to add the credits according to the bet number and the pattern payout to the credits owned by the player (S68). The bet number when the bonus game trigger is achieved is continuously used as the bet number during the bonus game, and accumulation or payout of the credits according to the bet number is executed. After the payout process (S68), the program moves to S69. On the other hand, if it is determined that no winning pattern is achieved (S67: NO), the program goes on to S69 without doing anything.

At S69, the main CPU 41 reads out the bonus game number T stored in the RAM 43 and subtracts one from the value of the read-out game number T. And the game number T after subtraction is stored in the RAM 43 again.

Then, at S70, the main CPU 41 determines if the bonus game number T stored in the RAM 43 becomes zero or not. As a result, if it is determined that the bonus game number T is not zero (S70: NO), the program returns to S62, and the above-mentioned process is repeated. On the other hand, if it is determined that the game number T is zero (S70: YES), the bonus game process is finished.

As described above, in the slot machine 1 according to the embodiment, the number of times of the game executed continuously (number of times to be played for one set) is set in the game condition setting process (S11), and the game is continuously played for the number of times.

At execution of the game for the number of times, lottery is carried out for the number of times at the lottery process (S13), and at the staging mode determining process (S42) of the reel rotation control process (S14), rotation control of the reels 5L, 5C, and 5R and the staging mode at reel rotation are determined according to the number of times to be played and the lottery result for the number of times.

Specifically, at the staging mode determining process (S42), the staging pattern table (FIG. 13) is referred to, and the staging pattern at the reel rotation is set according to the number of times to be played and the lottery result for the number of times. At this time, the set staging pattern has a staging period corresponding to the number of times to be played. Therefore, since by setting the number of times to be played a period available for staging can be prolonged, time limitation is relaxed and more diversified staging can be provided.

Moreover, since the staging pattern is set according to the lottery result for the set number of times to be played, the lottery result can be notified by the staging pattern, and reliability by the player on the staging can be improved. Owing to this, since the staging can attract the player more, a monotonous impression is not given to the player even in the base game, not in the bonus game, so that the player can fully enjoy the game.

Also, at the staging mode determining process (S42), the required time table (FIG. 12) is referred to, and the “required time per game”, which is a time required for a single game is determined on the basis of the set number of times to be played. This “required time per game” is, as shown in the required time table (FIG. 12), set so that the larger the number of times to be played is, the shorter the time becomes. Thus, the same number of times of the game can be played in a shorter time as compared with the case where the game is played each time. Therefore, since the period when the player occupies the slot machine 1 can be reduced, the operating rate of the slot machine 1 can be improved.

Also, during execution of the game for the set number of times, the game is played continuously, and the period relating to operation of the bet and the like required when the game is played each time may be executed only once. That is, in this regard, too, the period when the player occupies the slot machine 1 can be reduced, and the operating rate of the slot machine 1 can be improved.

Moreover, in the slot machine 1 according to the embodiment, at the game condition setting process (S11), the number of credits required for game execution for the number of times is discounted on the basis of the number of times to be played and the number of bets (See FIG. 8). Therefore, if the player sets the large number of times, the player can play the game with the smaller number of credits than the case where the game is played for the same number of times each time. Also, since the player tends to set the larger number of times to be played, the operating rate of the slot machine 1 can be further improved.

It is to be noted that the present invention is not limited to the above embodiment, but it is needless to say that various improvement and deformation are possible within a range not departing from the gist of the present invention.

For example, in the embodiment, variable display of symbols is made using the reels 5L, 5C, and 5R, but it is not limited to this mode. For example, the variable display of symbols may be made using a display means such as a liquid crystal display. Also, the number of reels is not limited to three. That is, it can be also applied to a so-called video slot.

Moreover, it is constituted such that the number of winning the “BONUS7” in the lottery result for the number of times to be played is referred to in determining the staging pattern in the embodiment, but it is only necessary to be based on the lottery result for the number of times to be played.

For example, it may be constituted such that, in the staging pattern table, the staging is performed in the staging pattern according to the achieved winning pattern by setting different staging patterns according to the achieved winning pattern for every set number of times to be played. In this case, the staging pattern is determined on the basis of the most advantageous winning pattern to the player in the achieved winning patterns in the lottery result for the number of times to be played. That is, when the most advantageous winning pattern “BONUS7” is not won, the staging pattern is determined on the basis of the winning pattern with more payout.

Also, it may be constituted such that, in the lottery result for the number of times to be played, the staging pattern is determined on the basis of the winning pattern with the largest number of winning times.

Also, the embodiment is constituted such that the discount rate is determined and the required number of credits is calculated on the basis of the set number of times to be played and the number of bets, but the constitution may be such that the discount rate is determined and the required number of credits is calculated only on the basis of the set number of times to be played.

As described above in detail, the present invention provides a gaming machine capable of various staging by playing a game for the set number of times as a single set while improving the operating rate of the gaming machine.

A gaming machine (a slot machine 1, for example) according to the present invention comprises: a gaming medium input means (a coin slot 21 as a gaming medium input unit, for example) by which a gaming medium used as a consideration of game execution is to be inputted; a permitting means (a main CPU 41 as a processor, S11, for example) for permitting execution of the game when the gaming media inputted by the above gaming medium input means reach a required amount; a staging means (a lower image display panel 6 as a first display area which displays a staging, for example) for staging at the game execution; a plurality of rows of variable display means (reels 5L, 5C, and 5R as second displays which respectively display a plurality of symbols in a variable state and in a stopped state, for example) for variable display of a plurality of symbols; a lottery means (the main CPU 41 as a processor, S13, for example) for drawing a lottery of a stop mode of symbols (that is, a lottery of symbols in a stopped state) displayed in the above variable display means; an award providing means (the main CPU 41 as a processor, S15, for example) for providing an award to a player on the basis of a lottery result of the above lottery means; a lottery setting means (a game setting portion 7, the main CPU 41 as a processor, S11, for example) for setting a number of times of the lottery by the above lottery means; a lottery control means (the main CPU 41 as a processor, for example) for drawing a lottery for the number of times set by the above lottery setting means using the lottery means; a game executing means (the main CPU 41, a sub CPU 61 both as a processor, for example) for executing the game for the number of times set by the above lottery setting means as a single set on the basis of the lottery result for the number of times set by the lottery setting means; and a staging setting means (the main CPU 41 as a processor, S42, for example) for setting staging to be executed by the staging means are provided.

The “gaming medium” includes coins, bills or electronic valuable information corresponding to them as well as medals, tokens, electronic money, tickets, etc. In addition, a single game only needs to include a single lottery, and it also includes the case where a single game is constituted by a flow from start of variable display of symbols to display in the stopped state on the basis of a lottery result. Moreover, one set is constituted by a plurality of times of game on the basis of the lottery results for the number of times set by the lottery setting means.

In the above gaming machine, when the gaming media inputted from the gaming medium input means reach a predetermined required amount, a plurality of symbols are variably displayed on a plurality of rows of the variable display means, respectively, and after a predetermined period of time has elapsed, display of symbols in the stopped state is made in a stop mode on the basis of the lottery result of the lottery means. At this time, staging to increase interest in the game is executed by the staging means. Then, on the basis of the lottery result of the lottery means, an award is provided to the player.

Here, when the number of times of lottery by the lottery means is set by the lottery setting means, the lottery for the set number of times by the lottery means is executed by the lottery control means and the set number of times to be played is executed as a single set by the game executing means on the basis of the lottery result for the set number of times to be played.

In addition, staging is set by the staging setting means on the basis of the lottery result for the number of times set by the lottery setting means and the staging is executed by the staging means.

Owing to this, since the number of times set by the lottery setting means is executed as a single set, the period from the variable display of symbols to display in the stopped state in the variable display means can be continuously used as a period available for staging for the set number of times to be played. That is, since the period available for one staging is prolonged, diversified staging can be executed, which increases interest for the player and can prevent giving monotonous impression.

Moreover, since the staging is determined on the basis of the lottery result, more reliable staging can be provided, and pleasure in watching the staging is increased.

Also, since the period of game for the number of times set by the lottery setting means can be surely played by the player, the operating rate of the gaming machine can be improved.

Preferably, the gaming machine further comprises a discount means (the main CPU 41 as a processor, S24, for example) for reducing a required amount of gaming media in the permitting means (the main CPU 41 as a processor, S11, for example) in accordance with the number of times set by the lottery setting means (a game setting portion 7, the main CPU 41 as a processor, S11, for example).

According to this gaming machine, the required amount of gaming media in the permitting means is reduced according to the number of times set by the lottery setting means. Owing to this, since consumption of the gaming media is smaller in playing of a plurality of numbers of times of the game as a single set than in playing each time, the player would set the plurality of times of lottery by the lottery setting means. Then, the period of game for the number of times set by the lottery setting means is surely played by the player and thus, the operating rate of the gaming machine can be improved.

What is claimed is:

1. A gaming machine comprising:
a gaming medium input unit by which a gaming medium used as a consideration of game execution is to be inputted;
a first display which displays a staging at the game execution;
a plurality of second displays which respectively display a plurality of symbols in a variable state and in a stopped state;
a processor permitting execution of a game when the gaming media inputted by the gaming medium input unit reach a required amount, and drawing a lottery of a stop mode of symbols displayed by the second displays, and providing an award to a player on the basis of a lottery result, and setting a number of times of the lottery, and drawing a lottery for the number of times, and executing the game for the number of times as one set on the basis of the lottery result for the number of times, and setting the staging displayed by the first display on the basis of the lottery result for the number of times.

2. The gaming machine according to claim 1 wherein the processor reduces the required amount of the gaming media in accordance with the number of times of the lottery.
